(19) United States
(12) Patent Application Publication
(10) Pub. No.: US 2015/0093522 A1
(43) Pub. Date: Apr. 2, 2015

(54) Hydrophobic/Hydrophilic Patterned Surfaces for Creation of Condensation Images

(71) Applicants: Warren Taylor, Golela, CA (US); Sienna Cordoba-Taylor, Goleta, CA (US)

(72) Inventors: Warren Taylor, Golela, CA (US); Sienna Cordoba-Taylor, Goleta, CA (US)

(21) Appl. No.: 14/492,564

(22) Filed: Sep. 22, 2014

Related U.S. Application Data
(60) Provisional application No. 61/883,956, filed on Sep. 27, 2013.

(51) Int. Cl. B44C 1/00; A44C 27/00; B44C 1/22; B05D 5/04; B05D 3/06

(52) U.S. Cl. CPC B44C 1/00; B05D 5/04; B05D 3/065; B05D 3/068; B44C 1/227; A44C 27/001
USPC 428/28; 427/256; 427/282; 427/535; 427/558; 216/28

(57) ABSTRACT

A method for creating a condensation image on a piece of jewelry using chemical patterning techniques which create covalently attached (or other strong chemical bond), ultrathin (less than 10 nm), hydrophobic/hydrophilic monolayer patterns on a surface. These techniques allow the deposition of ultrathin films (e.g. less than 10 nanometers thick) which are invisible to the naked eye making the patterns only visible when condensation has formed at the surface. Hydrophobic/hydrophilic layers can be created by attaching slimes having differing hydrophobicity/hydrophilicity characteristics on silicon wafers,

### CROSS-REFERENCE TO RELATED APPLICATION

This patent application claims the benefit of U.S. Provisional Patent Application Ser. No. 61/883,956, entitled “Hydrophobic/hydrophilic patterned surfaces for creation of condensation art/images/text,” filed Sep. 27, 2013, which application is incorporated in its entirety here by this reference.

### TECHNICAL FIELD

This invention relates to methods of creating images on personal effects with condensation.

### BACKGROUND

There is a never-ending need for new and creative ideas and designs for jewelry. Given that jewelry is a fashion statement, its value is derived from its appearance and rarity. It is commonplace for the aesthetic appeal of a piece of jewelry to be permanent. What is rare is for the aesthetic appeal of the piece of jewelry to appear and disappear based on environmental factors, such as the presence and absence of condensation.

The problem is creating condensation imagery, such as art and/or text, which can be cleaned without removing the chemicals which create the condensation imagery. Another problem is creating condensation art which cannot be seen with the naked eye before it is breathed upon; thereby giving the device a surprise or secret nature. This art work can be placed on mirror like surfaces in personal lockets or on drinking glasses, beverage bottles and cans, and the like.

One technique may involve lightly depositing grease onto a surface. But this does not result in a covalently attached ultrathin hydrophobic/hydrophilic monolayer pattern. Art made by this method cannot be washed; otherwise, the grease would be washed away or smeared. In addition, the grease is oftentimes visible with the naked eye on close inspection.

For the foregoing reasons there is a need for a new method and device to create a new piece of jewelry or other personal effect that can maintain permanent, secret imagery that is only visible under certain conditions.

### SUMMARY

The present invention is directed towards a method of creating images on a surface using condensation. A surface is permanently coated with patterns of hydrophobic and hydrophilic compounds. To the naked eye, these patterns are not visible. But when condensation forms upon the surface, artistic imagery, such as pictures, designs, text, and the like, become visible clue to the pattern of differently sized and shaped water droplets that form based on whether the water droplets are repelled by or miscible with the hydrophobic and hydrophilic regions, respectively, of the surface. Due to the permanence of the hydrophobic and hydrophilic compounds on the surface, the same image can be displayed repeatedly, even after the surface is cleaned.

When condensation forms on a hydrophobic surface the resulting water droplets have a high contact angle and tend to form ball shaped droplets. When condensation forms on a hydrophilic surface the resulting droplets have a low contact angle and tend to look like flattened balls. If a surface is patterned with hydrophobic regions and hydrophilic regions and condensation forms on the surface then the underlying hydrophobic/hydrophilic pattern will in turn result in a pattern of high and low contact angle water droplets, which can be seen by the naked eye.

A crucial feature of this invention is that the hydrophobic/hydrophilic pattern must be permanent and not removable by washing by typical means used to wash personal effects. This will enable the invention to be used many times over and enable the surface to be cleaned in order to remove grease or other contamination which may distort the resulting condensation pattern.

A way to achieve this is to attach the hydrophobic and hydrophilic molecules to the surface with a strong chemical bond, such as a covalent bond, ionic bond, co-ordination bonds, and the like.

Another crucial feature of this invention is that the underlying artistic imagery is not noticeable to a viewer with good eyesight when condensation is not present upon the surface. In other words, the surface appears blank to the naked eye, and that the underlying artistic imagery is only visible when condensation is present upon the surface. In order to achieve this feature of the invention the heights of the hydrophilic and hydrophobic regions must be comparable. Numerous surface science techniques can achieve this criterion.

Importantly these technologies satisfy the two invention criteria specified above, i.e., that the hydrophobic/hydrophilic pattern be bound to the substrate surface via strong chemical bonds such as covalent, ionic, and/or co-ordination bonds, and that the difference in height between the hydrophobic and hydrophilic domains of the pattern not be visibly different in height or color so that the underlying hydrophobic/hydrophilic pattern cannot be seen with the naked eye in the absence of condensation.

Generally speaking these surface patterning techniques which satisfy the invention criteria can be divided into three main approaches: 1) attaching hydrophobic/hydrophilic molecules to the surface through strong chemical bonds such as covalent, co-ordination or ionic bonds, 2) cleaving or etching away covalently bound molecules, revealing a hydrophobic/hydrophilic pattern, and 3) altering the chemical structure (e.g. bond angles) on the surface without adding or removing material which results in a change in wettability which can produce a hydrophobic/hydrophilic pattern.

There are numerous ways to create covalently attached ultrathin hydrophobic/hydrophilic monolayer patterns. In essence one requires a substrate with a chemical functionality which enables the addition or subtraction or rearrangement of molecules at the surface. Chemical patterning techniques, such as stamp or lithographic printing, monolayer or polymer brush technology, inkjet printing, mask printing, and the like may be used. Once the patterns are created on the surface, the surface can be applied to a personal effect, such as jewelry.

### BRIEF DESCRIPTION OF DRAWINGS

FIG. 1 shows an embodiment of the present invention in the absence of condensation.

FIG. 2 shows the embodiment in FIG. 1 in the presence of condensation revealing the condensation image.

FIG. 3 shows the process of manufacturing an embodiment of the present invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention is directed towards a method for creating a condensation image using chemical patterning techniques which create covalently attached (or other strong chemical bond), ultrathin (less than 10 nm), hydrophobic/hydrophilic monolayer patterns on a surface, and a personal effect created using the method. By using chemical patterning techniques, condensation imagery can he created by hydrophobic/hydrophilic compounds, which are permanently tethered to the surface by covalent, or other strong chemical bonds, such as ionic bonds, co-ordination bonds, and the like. These techniques also allow the deposition of ultrathin films (e.g. less than 10 nanometers thick) which are invisible to the naked eye making the patterns only visible when condensation has formed at the surface. It is important that there is not a large difference in thickness or refractive index between the hydrophobic and hydrophilic part of the pattern. This can he achieved by using covalently attached ultrathin chemical monolayers. Such methods can be applied to jewelry to add a unique feature to the jewelry.

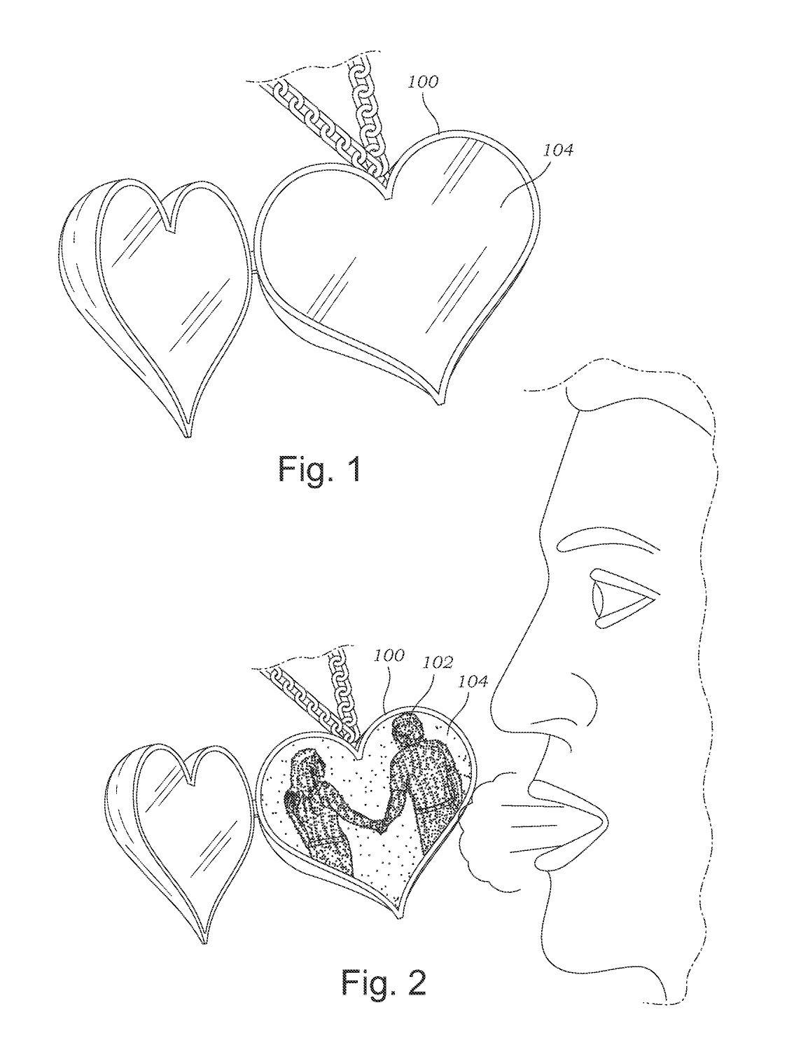

As such, one embodiment of the invention of the present application, as shown in FIGS. 1 and 2, comprises a personal effect 100 upon which the condensation image 102 is to be generated, a silicon wafer 104 polished with a native oxide layer affixed to the personal effect 100, and hydrophobic and hydrophilic compounds chemically attached to the silicon wafer 104 in a pattern that creates the aesthetically pleasing condensation image 102, such as art or text. In other words, the hydrophobic and hydrophilic compounds are arranged on the surface using surface patterning techniques to mimic the condensation image. So, when there is no condensation on the silicon wafer, the silicon wafer is blank as shown in FIG. 1, But, when condensation is generated on the silicon wafer, due to the complementary patterning of the hydrophobic and hydrophilic molecules, the condensation pattern reveals the condensation image 102, as shown in FIG. 2. By way of example only, the hydrophobic region may constitute the background of the condensation image and the hydrophilic region may constitute the foreground of the condensation image.

The personal effect 100 may be an item that can be carried around by the user. Preferably, the personal effect 100 is something that can he worn or adorned on the user. For example, jewelry, such as necklaces, bracelets, rings, watches, brooches, amulets, charms, lockets, and the like, may be suitable personal effects 100 upon which the silicon wafer 104 containing hydrophobic and hydrophilic regions can he attached to create condensation imagery 102. Other personal effects 100 that can also benefit from this technology include, but are not limited to, dinnerware, and in particular, glasses that are used for cold drinks. In such cases, ice may be added to the drink, thereby causing the formation of condensation on the glass surface. With the silicon wafer 104 applied, the condensation would cause unique imagery 102 to show up on the glass.

The silicon acts as the physical substrate, supplying strength and rigidity. Also, because silicon is polished, and therefore very flat, it also looks like a black mirror. The mirror quality of silicon is very important to the invention as it helps the user see the patterns which form in the condensation. However, the silicon wafer 104 does not necessarily have to be black. The flatness also helps produce good quality images, but is not necessary. The silicon wafer 104 may have a curved surface.

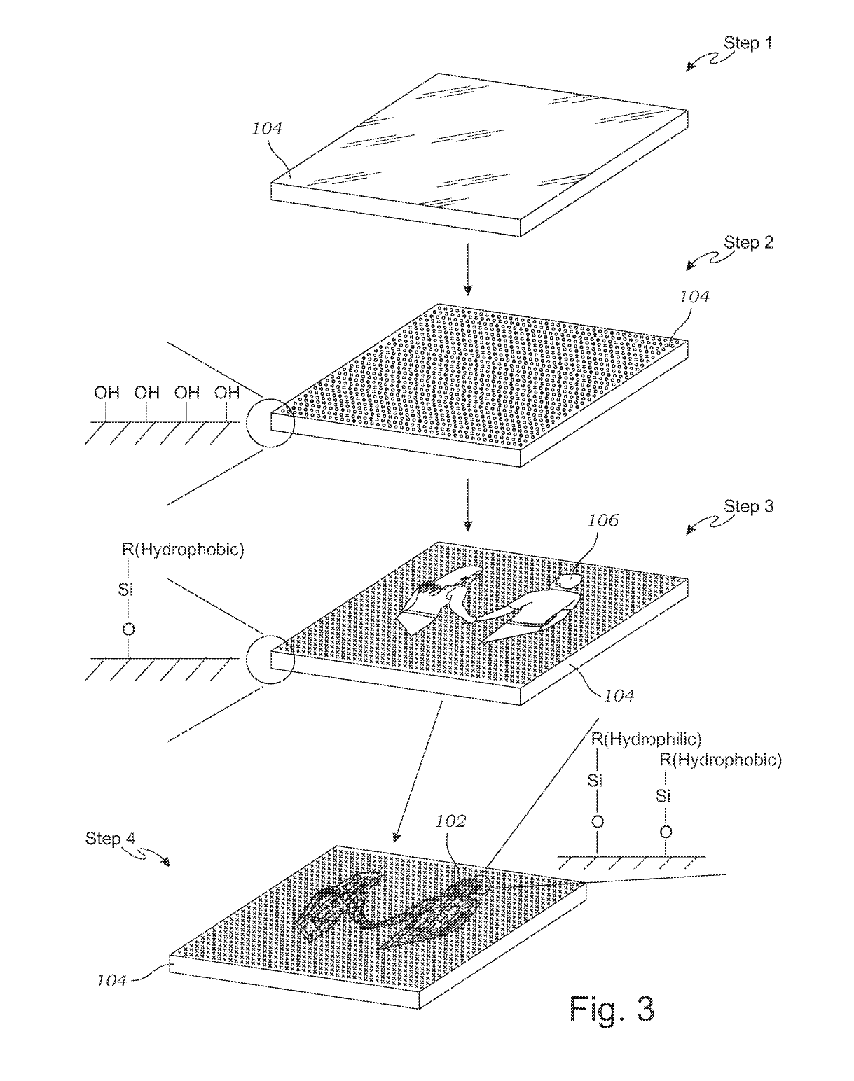

With reference to FIG. 3, to create a personal effect 100 with the condensation image 102, at step 1, the silicon wafer 104 should first be cleaned. At step 2, the cleaned silicon wafer 104 may he functionalized by adding a functional group onto the surface of the silicon wafer. Preferably, the silicon wafers 104 can be cleaned and functionalized by treating it with a solution containing sulfuric acid and hydrogen peroxide. Preferably, the ratio of sulfuric acid to hydrogen peroxide may range from approximately 3:1 to approximately 7:1. For example, the silicon wafers 104 may be placed in a piranha solution containing approximately a 3:1 ratio solution of sulfuric acid and hydrogen peroxide for 30 minutes and then removed and rinsed in water.

In some embodiments, the silicon wafer 104 may be functionalized by being placed in a UV-ozone chamber for about 10 minutes to about 1 hour, which creates ozone gas. Preferably, the treatment is from about 10 minutes to about 40 minutes. Preferably, the wavelength for the UV light ranges from approximately 185 nanometers to approximately 254 nanometers, In either case, the silicon wafer 104 is functionalized by creating hydroxyl groups (e.g. silanol groups (Si—OH)), on the surface of the silicon wafer 104 as shown in the inset at step 2. Oxygen plasma can also be used to create Si—OH groups on silicon (with native oxide, (silicon dioxide)), glass, and mica with similar exposure time as the UV-ozone treatment.

In some embodiments, for example, where gold, silver, copper, and similar metal surfaces are used, sulfhydryl groups can he added to create thiol groups instead of the silanol to generate the same effect. Any silanol thiol depending on the surface) could be used or other molecules with functionality which could be attached to a surface. These Si—OH groups then act as chemical functional groups which can he reacted with silanes or other molecules. Thus, polished silicon with a native oxide layer is used as the physical substrate for the covalently bound ultrathin hydrophobic/hydrophilic monolayer patterns. It is also very flat (smooth) and reflective meaning the imagery can he seen easily when condensation is present. Glass, mica, and other material with silicon may also he used.

In the preferred embodiment, silanes are chemically bonded to the silicon surface using a chemical patterning technique. By way of example only, silanes may be printed via a printing technique (inkjet, screen printing, stamping) onto the Si—OH surface. Under such a scheme, under the right chemical conditions, the silanes will react with portions of the Si—OH surface by creating covalently attached chemical patterns that cannot be removed by simple solvent washing. Any silane can he printed this way, however for the purpose of this invention it should he either a silane with extreme dislike for water (i.e a hydrophobic molecule such as a silane containing fluorine groups), or alternatively a silane with a high affinity for water (i.e a hydrophilic molecule such as a molecule containing lots of —OH groups or charged groups). In the inset at step 3 of FIG. 3, the silane is represented as a hydrophobic group. Silanes, ethoxy or methoxy can he reacted with Si—OH groups via hydrolytic deposition or anhydrous deposition. In hydrolytic deposition silanes are deposited from organic solvent such as toluene, acetone, ethanol, methanol, etc, in these solution water is sometimes added. Added water or trace water in the organic solvent/silane solution causes the ethoxy or methoxy labile groups to hydrolize like so R—Si(MeOH)+3H2O→R—Si(0H)3+3MeOH. The silanes can then condense and form strong hydrogen bonds with the Si—OH groups of the silicon. When heated to above 80 degrees centigrade, these strong hydrogen bonded silanes can then react forming covalent bonded silanes at the surface.

Silanes of varying hydrophobicity, (e.g. hydrophobic 1H,1H,2H,2H-Perfluorooctyltriethoxysilane and hydrophilic mPEG-silane) may be used to create the hydrophobic/hydrophilic monolayer. The silanes are the molecules which actually control the shape and size of the water droplets which form upon them, thus producing the condensation art. The larger the contrast in water affinity, the better the quality of the condensation image. These differences in droplet settlement result in a condensation image which can he seen with the naked eye revealing the underlying chemical pattern.

These silanes are covalently attached via printing to the silicon. Acetone may he used for the deposition of the silanes onto the silicon wafer. The different silanes produce different density and shaped water droplets which result in a condensation pattern which reveals the underlying chemical pattern produced by the silanes.

Thus, via use of a suitable chemical patterning technique, the surfaces can be patterned with suitable molecules which produce a covalently bound ultrathin hydrophobic/hydrophilic monolayer pattern. For example, in some embodiments, silanes of differing hydrophobicity are screen printed onto the silicon wafer 104, in order to produce hydrophobic/hydrophilic patterns. For example, mask printing may involve placing a screen mask 106 over the silicon wafer 104 in a manner that exposes a patterned surface due to cutouts in the screen mask (unmasked area) for which a hydrophobic region is desired as shown in step 3 of FIG. 3. Screen masks can be made out of any material that can act as barrier to the solution containing the silanes. These typically consist of some fine woven fabric mesh that has had a photoemulsion polymer cured into the image desired using a transparency mask. The unmasked area is then exposed to a solution containing acetone and hydrophobic silanes, such as perfluoro-silane, aminosilane, and the like, from about 2 minutes to about 1 hour. Preferably, the silicon wafers 104 may be heated to above 80 degrees centigrade for about 1 to about 24 hours prior to exposure to acetone and hydrophobic silanes. Preferably, the solution contains approximately 2 percent by weight silanes, and approximately 98 percent by weight. acetone. Other solvents, such as toluene, methanol, ethanol, and the like can also be used in place of acetone. These silanes react with exposed Si—OH groups (in the unmasked area) when dissolved in acetone to produce covalently attached monolayers (as shown in the inset of step 3 of FIG. 3), while the masked portions do not react with the silane. Other printing techniques, such as inkjet printing, can also be used, particularly for mass production. The solution is washed away and rinsed in various solvents, such as acetone, methanol, water, and the like. Then the screen mask may be removed. The hydrophobic region in combination with the hydrophilic region mimics the condensation image so that the condensation image can be formed when condensation is present, For example, the hydrophobic regions may constitute the foreground of the condensation image and the non-hydrophobic region may constitute the background, or vice versa.

In some embodiments, in order to increase the contrast of the surface, after the initial patterning with the first solution containing silanes having a particular affinity for water (in the example above, hydrophobic silanes), the silicon surface may be backfilled with a silane with an alternative or opposite affinity for water (e.g. hydrophilic silanes) so as to create a better contrast in the condensation image as shown in step 4 of FIG. 3. This can be done by simply placing the silicon wafer 104 in a second solution containing the preferred silane and waiting an approximately 2 minutes to approximately 1 hour for the silane to react and attach to areas of the surface not already patterned from the previous printing step, as discussed above for the first solution of silanes; thereby creating a high contrast region where the hydrophobic silane and hydrophilic silane are adjacent to each other as shown in the inset of at step 4 in FIG. 3. Preferably, the solution contains approximately 2 percent by weight silanes, and approximately 98 percent by weight acetone. Other solvents, such as toluene, methanol, ethanol, and the like can also be used in place of acetone.

In the example above, hydrophilic silanes, such as m(PEG)-silane, can he attached to the areas of the surface which have not been printed on with the hydrophobic silanes (i.e. the areas covered by the screen mask). To do this, the silicon wafer 104 may be submerged in an acetone solution containing the hydrophilic silane. Another hydrophilic silane may he a silane terminated PEO (polyethylene oxide). This step is not necessary for producing the inventions as there is often a large enough contrast in water wettability between the deposited hydrophobic silane and the already hydrophilic Si—OH surface.

The steps can be reversed with the hydrophilic silane attached first using the screen mask and the hydrophobic silane attached second in order to produce the high contrast surface.

The surface is then cleaned in various solvents, such as acetone, methanol, water, and the like to remove the unwanted or unbound silanes or other chemical contamination. The result is a surface which to the naked eye appears to be a conventional piece of polished surface, however, if the viewer is to breathe on the surface, condensation will form in the shape of the hydrophobic/hydrophilic silane chemical pattern which was deposited upon the surface. This pattern will be observed only when atmospheric conditions allow the adsorption of condensation upon the surface. As the chemical patterns are ultra thin (less than 10 nm) they cannot be seen easily with the naked eye, giving the invention a secret or surprise quality which is the core principle of the invention. Also due to the silanes being covalently attached to the silicon surface, the chemical patterns will not wash away with solvent washing, meaning the surfaces can be cleaned to remove contamination that may hamper their performance and functionality.

Once the printing steps are complete, the silicon wafer containing the hydrophobic/hydrophilic patterned surface can be integrated with the personal effect, such as a piece of jewelry, and the invention is complete.

In some embodiments, the silicon wafer 104 may already contain a base image on the top surface. When treated as described herein, the hidden image may reveal a unique image or message in conjunction with the base image.

There are other methods which could produce hydrophobic/hydrophilic monolayer patterns which have the quality of not being visible to the naked eye and covalently attached to a plain reflective surface. For example, silicon could be coated with aminosilanes, then epoxy terminated hydrophobic/hydrophilic molecules could be printed onto the surface, creating covalently attached patterns. In some embodiments, silanes with allyl groups could be deposited on the surface then by selectively exposing h surface to UV light in the presence of a solution containing a thiol-functionalized hydrophobic/hydrophilic molecule and a photo initiator such as DMPA. In some embodiments, thiol termination molecules creating thiol hydrophobic/philic molecules can be printed or grafted onto gold or silver surfaces. In some embodiments, lithography techniques could be used to attach molecules via light mediated chemistry upon modified surfaces or alternative radiation of any type could be used to remove molecules or chemically alter molecules at a surface creating a hydrophobic/hydrophilic pattern. In essence any surface with chemical functionality could be patterned this way.

In order to use the invention the surface must either be placed in an environment where condensation can form, such as a steamy room, such as a shower room, or alternatively condensation can be formed momentarily by breathing on the surface. Such surfaces could be incorporated into jewelry. For instance, lockets may contain the hydrophobic/hydrophilic surface on the inside. When opened, initially the hydrophobic/hydrophilic pattern cannot be seen, although other “background” or base images printed or engraved on the locket may be visible, such as a picture of a loved one. When warm breath is applied to the surface, however, the background or base image may be further adorned with emotive text that instantly appears, such as “Dad loves you,” created by the hydrophobic/hydrophilic patterning.

Other jewelry ideas could he on earrings. Another application is decorative text, images, art, patterns on glassware that often collects condensation, such as but not limited to, wine glasses, beer glasses, drinking glasses, bathroom mirrors, glass refrigerator doors, household windows, etc. Another use is for art pieces which can either be made to fog up mechanically or placed in an environment, which often receives condensation. Another example of glassware could he two planes of glass with a small amount of water between at the bottom. If the water is heated up it will evaporate and condense on the sides of glass revealing imagery, art, text or decorative patterns.

The main advantage is that the images and art are permanent, in other words they are not removed by washing with various solvents and detergents. This means that the art and images lasts a long time and they can also be cleaned without losing the ability to create the image. Another added benefit is that the hydrophobic/hydrophilic patterns are ultrathin and smooth (i.e no significant height differences between hydrophobic and hydrophilic domains) meaning it is very difficult to see the images with the naked eye, in turn meaning that they can only he observed when condensation is present at their surface.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of creating a surface on a piece of jewelry that can reveal a condensation image in the presence of condensation, comprising;
a. treating a silicon water with a solution comprising sulfuric acid and hydrogen peroxide at a ratio of 3:1 of sulfuric acid to hydrogen;
b. masking the silicon wafer with a screen mask having cutouts in an artistic pattern that mimics the condensation image;
c. treating the masked silicon wafer with a first solution comprising a first silane compound and acetone, wherein the first silane compound has a first affinity for water;
d. washing the first solution off the masked silicon wafer with a solvent;
e. removing the screen mask from the silicon wafer;
f. treating the masked silicon wafer with a second solution comprising a second silane compound and acetone, wherein the second silane compound has a second affinity for water different from the first affinity for water of the first silane compound; and
g. affixing the silicon wafer onto the piece of jewelry, whereby the condensation image is revealed on the silicon wafer in the presence of condensation and the condensation image disappears when the condensation is removed.

2. A method of creating a surface on a personal effect configured to reveal a condensation image, comprising:
a. adding a functional group onto a silicon surface to create a functionalized silicon surface;
b. treating the functionalized silicon surface with a first silane solution having comprising silanes having a first affinity for water to generate first silane regions;
c. placing the silicon surface treated with the first silane solution on the personal effect, whereby generating condensation on the silicon surface reveals the condensation image due to the first silane regions, and removal of the condensation causes the condensation image to disappear.

3. The method of claim 2, wherein the first silane solution is applied using a technique selected from the group consisting of a mask printing technique and an inkjet printing technique.

4. The method of claim 2, wherein a screen mask is applied to the silicon surface, wherein the screen mask is patterned with cutouts that mimic the condensation image so that the first silane regions can be created.

5. The method of claim 4, further comprising the step of removing the screen mask and applying a second silane solution comprising silanes having a second affinity for water different from the first affinity for water of the silanes in the first silane solution to create second silane regions complementing the first silane regions.

6. The method of claim 2, wherein the functional group is the hydroxyl group to create silanol groups on the silicon surface.

7. The method of claim 2, wherein the silanes in the first silane solution is selected from the group consisting of 1H,1H,2H,2H-Perfluorooctyltriethoxysilane and mPEG-silane.

8. The method of claim 7, wherein the first silane solution further comprises acetone solution.

9. The method of claim 2, wherein the functional group is added to the silicon surface by treating the silicon surface with a solution comprising sulfuric acid and hydrogen peroxide at a ration of 3:1.

10. The method of claim 2, wherein the functional group is added to the silicon surface by a technique selected from the group consisting of treatment of the silicon surface with UV and ozone, and treatment of the silicon surface with oxygen plasma.

11. The method of claim 2, wherein the silicon surface comprises a visible base image and the condensation image supplements the base image when condensation is applied to the silicon surface.

12. A method of creating a condensation image on a personal effect, comprising
a. adding a functional group on to a surface to create a functionalized surface;
b. using a surface patterning technique to create regions of hydrophobicity and regions of hydrophilicity on the surface a pattern that mimics the condensation image; and
c. applying the surface to the personal effect, whereby when condensation s present on the surface the condensation image is revealed, and when condensation is removed from the surface the condensation image is hidden.

13. The method of claim 12, wherein die surface patterning technique is selected from the group consisting of 1) attaching hydrophobic and hydrophilic molecules to the surface through chemical bonds, 2) breaking covalent bound molecules to reveal regions of hydrophobicity and regions of hydrophilicity in a pattern that mimics the condensation image, and 3) altering a chemical structure of molecules on the surface.

14. The method of claim 13, wherein the surface pattern technique is selected from the group consisting of inkjet printing, mask printing, and lithography techniques.

15. The method of claim 12, wherein the regions of hydrophobicity and the regions of hydrophilicity are created by chemically bonding hydrophobic compounds and hydrophilic compounds to the surface.

16. The method of claim 12, wherein the regions of hydrophobicity and the regions of hydrophilicity are created by covalently bonding hydrophobic compounds and hydrophilic compounds to the surface in a pattern that mimics the condensation image.

17. The method of claim 12, wherein the personal effect is selected from the group consisting of jewelry, dinnerware, and glassware.

18. The method of claim 12, wherein the functional group is selected from the group consisting of a hydroxyl group and a suflhydryl group.

19. A jewelry made according to the method of claim 12.
